(19) United States
(12) Patent Application Publication
(10) Pub. No.: US 2026/0366603 A1
(43) Pub. Date: Nov. 19, 2026

(54) ACTUATOR AND MICRO-POSITIONER USING SAME

(71) Applicant: 3SAE Technologies, Inc., Franklin, TN (US)

(72) Inventors: Robert Wiley, Franklin, TN (US); Robert Aronoff, Tiburon, CA (US); Benjamin A. Smith-Knisley, N. Rockvale, TN (US)

(21) Appl. No.: 19/141,158

(22) PCT Filed: Dec. 27, 2023
(86) PCT No.: PCT/US2023/086037

§ 371 Date: Jun. 19, 2025

Related U.S. Application Data
(60) Provisional application No. 63/435,460, filed on Dec. 27, 2022.
(60) Provisional application No. 63/435,462, filed on Dec. 27, 2022.

(51) Int. Cl. F16H 25/22; H02K 7/06; H02K 7/10

(52) U.S. Cl. CPC F16H 25/2204; H02K 7/06; H02K 7/10

(57) ABSTRACT

Various aspects of the present invention relate to a micro-positioner, comprising: a carriage comprising a plurality of walls defining an internal volume; and a plurality of actuators extending from the plurality of walls toward the internal volume and configured to support and move a workpiece. The plurality of walls and actuators include at least one active actuator extending from a first carriage wall and at least one passive actuator extending from a second carriage wall, opposite the first carriage wall. The micro-positioner has myriad applications and can be used, for example, in a fiber optic processing machine to finely position one or more fibers and/or fiber ends.

### RELATED APPLICATIONS

This application claims priority to U.S. Provisional Patent Application No. 63/435,460, filed Dec. 27, 2023, entitled MICRO-POSITIONER and U.S. Provisional Patent Application No. 63/435,462, filed Dec. 27, 2023, entitled WOBBLE-FREE ACTUATOR, each of which is hereby incorporated by reference in its entirety.

The present application may be related to U.S. patent application Ser. No. 17/570,474, filed Jan. 7, 2022, entitled MULTI-AXIS POSITIONER, which is a continuation of U.S. patent application Ser. No. 16/930,638, filed on Jul. 16, 2020, entitled MULTI-AXIS POSITIONER, now U.S. Pat. No. 11,269,143 issued on Mar. 8, 2022, which is a continuation of U.S. patent application Ser. No. 16/275,601, filed on Feb. 14, 2019, entitled MULTI-AXIS RELATIVE POSITIONING STAGE, now issued U.S. Pat. No. 10,746,928 issued on Aug. 18, 2020, which is a division of U.S. patent application Ser. No. 15/720,006, filed on Sep. 29, 2017, entitled MULTI-AXIS RELATIVE POSITIONING STAGE, now issued U.S. Pat. No. 10,429,587 issued on Oct. 1, 2019, which claims benefit of U.S. Provisional Application No. 62/402,674, filed on Sep. 30, 2016, entitled KINEMATIC MULTI AXIS RELATIVE POSITIONING STAGE, which are hereby incorporated by reference in their entireties.

The present application may be related to International Application No. PCT/US17/054272, filed Sep. 29, 2017, entitled MULTI-AXIS RELATIVE POSITIONING STAGE, Publication No. WO 2018/064462, published on Apr. 5, 2018, which is hereby incorporated by reference in its entirety.

### FIELD OF INTEREST

The present inventive concepts relate to the field of actuators, micro-positioners, and micro-positioner stages, which can have application in myriad systems and configurations.

### BACKGROUND

Position manipulators are employed in a vast array of applications to position objects, tools, or instruments with varying degrees of precision. A survey of kinematic joints, or kinematic pairs, that may be used in position manipulators are illustrated in FIG. 1, including: rigid (no motion), prismatic, revolute, parallel cylinders, cylindrical, spherical, planar, edge slider, cylindrical slider, point slider, spherical slider, and crossed cylinder.

The Stewart Platform (also referred to herein as a form of hexapod) is a multi-axis positioning stage made up of six actuators with spherical, ball, or universal joints at both ends of each actuator, for example. Hexapods are considered the world class multi-axis positioning stage design for most applications, but are often cost-prohibitive. One problem with hexapods is that it is a synergistic motion platform because of the mutual interaction of the actuators. That is, due to the mutual interaction of the actuators, none of the actuators can be moved independently; a given move requires many or all of the actuators to move different specific amounts and at different speed profiles to prevent the stage from binding. Additionally, these motion and speed profiles change continuously as the defined starting and ending points are changed. For this reason, a highly complex computer algorithm is required to individually calculate the distance to travel and speed profiles necessary for each actuator to get the top plate of the stage from point A to point B, even if a short distance single axis move is desired. As a result, a human operator is incapable of manually performing, even this simple move, without binding the stage.

Another significant disadvantage with a hexapod is that the stiffness of the joints (against off axis motion) dictates the “slop,” or “play,” and, therefore, the resolution of the stage. This is a design conflict because it is exponentially more difficult to make spherical joints (employed in hexapods) at tighter and tighter tolerances. That is, in the case where a designer makes a world class spherical bearing to maximize stage resolution and minimize slop, he has, by default, exacerbated two inherent issues. First, because of the rigidness of the spherical joints, the accuracy of the motion and speed profile requirements for each actuator increases exponentially to prevent binding. Second, the capability requirements of the actuators increase exponentially in order to achieve the required precision motions and speed profiles. As a result, improving the resolution of a hexapod requires an exponential increase in computing power for determining motion and speed profiles, an exponential increase in the performance capabilities of the actuators, and twelve high quality spherical bearings. All of these factors drive up the cost of a hexapod significantly.

Although hexapods typically cost from three to ten times as much as their kinematic chain counterpart, they are often preferred because they do not suffer from tolerance stack up issues. Ten microns of precision is not an uncommon positioner requirement for many applications and, for example, in the photonics industry, submicron precision is often required. At this date, hexapods typically cost from $60,000 to greater than $120,000, each depending on physical size, load limits, and precision requirements. An alternative precise position manipulator would be highly desirable.

3SAE Technologies from Franklin, TN, has developed micro-positioners described in U.S. Pat. Nos. 11,269,143, 10,746,928, and 10,429,587. Embodiments, of these micro-positioners can use a plurality of actuators to move a workpiece. The micro-positioners can include one or more electro-mechanical micro-positioners.

In systems that use actuators, each actuator can experience “wobble,” which can take the form of off-axis movement or vibration of the actuator shaft that can introduce inaccuracies in positioning of a workpiece engaged and moved by the actuator. In micro-positioners, where precision is essential, wobble can be extremely detrimental.

FIG. 2 is a side view of a linear actuator 200 of the prior art that can include a motor 206 that drives an actuator shaft 202. In example embodiments actuator shaft 202 may be driven in the positive or negative “Z” direction, coaxial with the shaft 202, through application of electrical signals applied to leads 204 under control, for example, of a processor (not shown). In example embodiments actuator 200 may be a precision linear actuator, for example.

FIG. 3 is a perspective view of a ball spline 300 including spline nut 302 of the prior art that may be coupled to the shaft 202 to the actuator 200, to form a motorized or electro-mechanical actuator with extended reach. A distal end of the shaft, opposite from the motor, can include a ball or other type of end to engage a workpiece.

### SUMMARY

In accordance with one aspect of the present disclosure, provided is a micro-positioner. In various embodiments, the micro-positioner can include a carriage having a plurality of walls configured to, at least partially, enclose a plate, block, workpiece, or workpiece support collectively “workpiece.” A carriage wall can include at least one active actuator and/or at least one passive actuator directed toward an internal volume of the carriage to engage, support, and move the workpiece.

In accordance with one aspect of the inventive concepts, provided is an actuator, comprising: a motor comprising a motor shaft; a ball spline coupled to the motor shaft and driven by the motor; and a dampening assembly configured to reduce a deviation in wobble of the ball spline when driven by the motor.

In various embodiments, the motor is configured to linearly drive the ball spline.

In various embodiments, the ball spline comprises a ball spline shaft and the assembly further comprises a ball-spline nut configured to couple the ball spline shaft to the motor shaft.

In various embodiments, the dampening assembly comprises a backlash reduction assembly configured to reduce motion of the ball spline relative to a workpiece and/or the motor.

In various embodiments, the backlash reduction assembly comprises: a housing through which passes the motor shaft and/or the ball spline shaft; and at least one backlash reduction element disposed within the housing and configured to reduce vibration and/or motion of the motor shaft and/or the ball spline shaft.

In various embodiments, the housing encases a portion of the motor shaft and/or the ball spline shaft and the at least one backlash reduction assembly.

In various embodiments, at least one backlash reduction assembly is coaxial with the motor shaft and/or the ball spline shaft.

In various embodiments, the at least one backlash reduction assembly comprises at least one spring.

In various embodiments, the assembly further comprises a ball or sphere on a distal end of the motor shaft and/or a ball spline shaft coupled to the motor shaft.

In various embodiments, the ball or sphere comprises and/or includes a magnetic material.

In various embodiments, the wobble-free actuator has a deviation in wobble in a range of between 3 microns to 6 microns.

In various embodiments, the wobble-free actuator has a deviation of about 1 micron. In various embodiments, the wobble-free actuator has a deviation of 1 micron, ±50%.

In accordance with another aspects of the inventive concepts, provided is a wobble-free actuator assembly, comprising a dampening assembly configured to reduce a deviation in wobble of a ball spline when driven by a motor shaft driven by a motor. The dampening assembly comprises a backlash reduction assembly configured to reduce motion of the ball spline relative to a workpiece and/or the motor.

In various embodiments, the backlash reduction assembly comprises: a housing through which passes the motor shaft and/or a ball spline shaft coupled to the motor shaft; and at least one backlash reduction element disposed within the housing and configured to reduce vibration and/or motion of the motor shaft and/or the ball spline shaft.

In various embodiments, the housing encases a portion of the motor shaft and/or the ball spline shaft and the at least one backlash reduction assembly.

In various embodiments, the at least one backlash reduction assembly is coaxial with the motor shaft and/or the ball spline shaft coupled to the motor shaft.

In various embodiments, the at least one backlash reduction assembly comprises at least one spring.

In various embodiments, the assembly further comprises a ball or sphere on a distal end of the motor shaft or a ball spline shaft coupled to the motor shaft.

In various embodiments, the ball or sphere comprises and/or includes a magnetic material.

In various embodiments, the wobble-free actuator assembly is configured to limit a deviation in wobble of the motor shaft and/or a ball spline shaft coupled to the motor shaft in a range of between 3 microns to 6 microns.

In various embodiments, the wobble-free actuator assembly is configured to limit a deviation in wobble of the motor shaft and/or a ball spline shaft coupled to the motor shaft to a deviation of about 1 micron.

In various embodiments, the wobble-free actuator assembly is configured to limit a deviation in wobble of the motor shaft and/or a ball spline shaft coupled to the motor shaft to a deviation of 1 micron, ±50%.

In accordance with aspects of the inventive concepts, provided is a wobble-free actuator kit, comprising: a motor having a motor shaft; a ball spline configured to couple to the motor shaft; and a dampening assembly configured to coupled to the motor and to reduce a deviation in wobble of the ball spline when driven by the motor.

In various embodiments, the motor is configured to linearly drive the ball spline.

In various embodiments, the ball spline comprises a ball spline shaft and the kit further comprises a ball-spline nut configured to couple the ball spline shaft to the motor shaft.

In various embodiments, the dampening assembly comprises a backlash reduction assembly configured to reduce motion of the ball spline relative to a workpiece and/or the motor.

In various embodiments, the backlash reduction assembly comprises: a housing through which passes the motor shaft and/or the ball spline shaft; and at least one backlash reduction element disposed within the housing and configured to reduce vibration and/or motion of the motor shaft and/or the ball spline shaft.

In various embodiments, the housing encases a portion of the motor shaft and/or the ball spline shaft and the at least one backlash reduction assembly.

In various embodiments, at least one backlash reduction assembly is coaxial with the motor shaft and/or the ball spline shaft.

In various embodiments, the at least one backlash reduction assembly comprises at least one spring.

In various embodiments, the kit further comprises a ball or sphere on a distal end of the motor shaft and/or a ball spline shaft coupled to the motor shaft.

In various embodiments, the ball or sphere comprises and/or includes a magnetic material.

In various embodiments, the wobble-free actuator has a deviation in wobble in a range of between 3 microns to 6 microns.

In various embodiments, the wobble-free actuator has a deviation of about 1 micron.

In various embodiments, the wobble-free actuator has a deviation of 1 micron, ±50%.

In accordance with another aspect of the inventive concepts, provided is a micro-positioner, comprising: a carriage comprising a plurality of walls defining an internal volume; and a plurality of actuators extending from the plurality of walls toward the internal volume and configured to support and move a workpiece. The plurality of actuators comprises at least one wobble-free actuator, including: a motor comprising a motor shaft; a ball spline coupled to the motor shaft and driven by the motor; and a dampening assembly configured to reduce a deviation in wobble of the ball spline when driven by the motor.

In various embodiments, the plurality of actuators includes: at least one active actuator extending from a first side wall of the carriage; and at least one passive actuator extending from a second side wall of the carriage, opposite the first side wall, wherein the joints formed by the end of the actuators and the workpiece are five degree of freedom joints.

In various embodiments, the first side wall further includes at least one passive actuator and the second side wall further includes at least one active actuator.

In various embodiments, the plurality of actuators is configured to positionally manipulate the workpiece within at least a two-dimensional (2D) coordinate system.

In various embodiments, the plurality of actuators is configured to positionally manipulate the workpiece within a three-dimensional (3D) coordinate system.

In various embodiments, the first side wall and the second side wall are parallel side walls and at least one of the active actuators is a wobble-free actuator.

In various embodiments, the carriage further comprises a third side wall and a fourth side wall opposite the third side wall.

In various embodiments, each of the plurality of walls includes one or more actuators from the plurality of actuators extending toward the internal volume.

In various embodiments, actuators extending from the first and second side walls extend and retract in an x-axis and actuators extending from the third and fourth side walls extend and retract in an y-axis.

In various embodiments, the carriage further comprises a bottom wall, from which the first, second, third, and fourth walls extend.

In various embodiments, the plurality of actuators includes at least one bottom actuator arranged to engage a bottom surface of the workpiece.

In various embodiments, the at least one bottom actuator is coupled to a bottom ball spline shaft through a lever and/or linkage and the bottom ball spline shaft extends through the bottom wall and engages the bottom surface of the workpiece.

In various embodiments, the bottom ball spline shaft is configured to extend and retract along a z-axis.

In various embodiments, the dampening comprises: a backlash reduction assembly configured to reduce motion of the ball spline relative to a workpiece and/or the motor.

In various embodiments, the backlash reduction assembly comprises: a housing through which passes the motor shaft and/or a ball spline shaft coupled to the motor shaft; and at least one backlash reduction element disposed within the housing and configured to reduce vibration and/or motion of the motor shaft and/or the ball spline shaft.

In various embodiments, the housing encases a portion of the motor shaft and/or the ball spline shaft and the at least one backlash reduction assembly.

In various embodiments, at least one backlash reduction assembly is coaxial with the motor shaft and/or the ball spline shaft coupled to the motor shaft.

In various embodiments, the at least one backlash reduction assembly comprises at least one spring.

In various embodiments, the micro-positioner further comprises a ball or sphere on a distal end of the motor shaft or a ball spline shaft coupled to the motor shaft.

In various embodiments, the ball or sphere comprises and/or includes a magnetic material.

In various embodiments, the wobble-free actuator assembly is configured to limit a deviation in wobble of the motor shaft and/or a ball spline shaft coupled to the motor shaft in a range of between 3 microns to 6 microns.

In various embodiments, the wobble-free actuator assembly is configured to limit a deviation in wobble of the motor shaft and/or a ball spline shaft coupled to the motor shaft to a deviation of about 1 micron.

In various embodiments, the wobble-free actuator assembly is configured to limit a deviation in wobble of the motor shaft and/or a ball spline shaft coupled to the motor shaft to a deviation of 1 micron, ±50%.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 illustrates a variety of conventional kinematic joints;

FIG. 2 is a top view of a motor that provides linear motion;

FIG. 3 is an angled side view of a ball spline;

FIG. 4 is an exploded view of an active actuator in accordance with aspects of the inventive concepts;

FIG. 5 is side view of the active actuator of FIG. 4;

FIG. 6 is an angled exploded view of an active actuator in accordance with aspects of inventive concepts;

FIG. 7 is a top view of a micro-positioner, with the workpiece in the center position in accordance with aspects of the inventive concepts;

FIG. 8 is a side view of a micro-positioner, with the workpiece in the center position in accordance with aspects of the inventive concepts;

FIG. 9 is a side view of a micro-positioner, with the workpiece in the center position in accordance with aspects of the inventive concepts;

FIG. 10 is a top view of a micro-positioner, with the workpiece in a max x-position, in accordance with aspects of the inventive concepts;

FIG. 11 is another top view of the micro-positioner of FIG. 7, with the workpiece in a min x-position, in accordance with aspects of the inventive concepts;

FIG. 12 is another top view of the micro-positioner of FIG. 7, with the workpiece in a max yaw position, in accordance with aspects of the inventive concepts;

FIG. 13 is another top view of the micro-positioner of FIG. 7, with the workpiece in a min yaw position in accordance with aspects of the inventive concepts;

FIG. 14 is another top view of the micro-positioner of FIG. 7, with the workpiece in a max pitch position, in accordance with aspects of the inventive concepts;

FIG. 15 is another top view of the micro-positioner of FIG. 7, with the workpiece in a min pitch position, in accordance with aspects of the inventive concepts;

FIG. 16 is another angled side view of the micro-positioner of FIG. 7, with the workpiece in an extended z position, in accordance with aspects of the inventive concepts;

FIG. 17 is another top view of the micro-positioner of FIG. 7, with the workpiece rotated in a max theta position, in accordance with aspects of the inventive concepts; and

FIG. 18 is a diagram of a fiber splicer comprising at least one micro-positioner, in accordance with the inventive concepts.

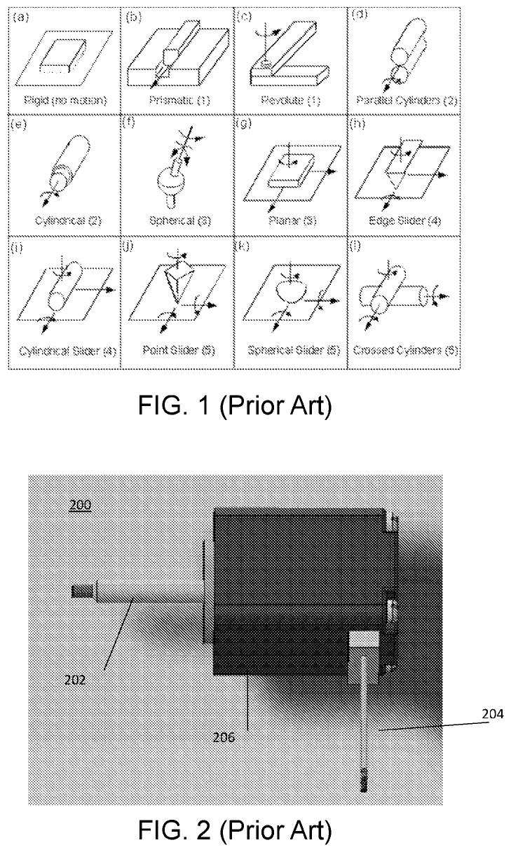

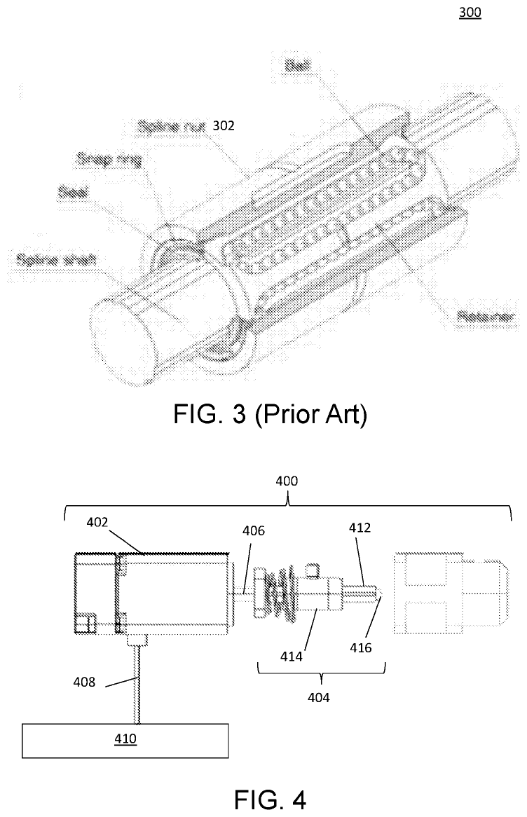

### DETAILED DESCRIPTION OF PREFERRED EMBODIMENTS

Various aspects of the inventive concepts will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but are to include deviations in shapes that result, for example, from manufacturing.

To the extent that functional features, operations, and/or steps are described herein, or otherwise understood to be included within various embodiments of the inventive concept, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor.

In various embodiments, a wobble-free actuator in accordance with aspects of the inventive concepts includes an electro-mechanical actuator in combination with a dampening mechanism. An active actuator may be an electro-mechanical actuator that moves in response to an electrical current and/or voltage and may be a linear actuator, for example. In various embodiments, the wobble-free actuator assembly, whether as part of a micro-positioner, a standalone actuator, or part of a kit, has a deviation in a range of between 3 microns to 6 microns. In various embodiments, the wobble-free actuator assembly, whether as part of a micro-positioner, a standalone actuator, or part of a kit, has a deviation of about 1 micron. In various embodiments, the wobble-free actuator assembly, whether as part of a micro-positioner, a standalone actuator, or part of a kit, has a deviation of about 1 micron, ±50%.

FIG. 4 is a side view of a motorized wobble-free actuator 400 comprising a motor 402 configured to drive a motor (or actuator) shaft 406 and a ball-spline assembly 404, in accordance with aspects of the inventive concepts. The actuator 400 is an active, electro-mechanical actuator having the motor coupled through the motor shaft 406 to the ball-spline assembly 404. The motor 402 creates the linear motion in a direction coaxial with the motor shaft 406 in response to electrical signals applied to leads 408 from processor 410. Linear motion from motor shaft 406 is conveyed to shaft 412 of the ball spline assembly 404, which travels linearly through ball spline carriage 414. In example embodiments, linear actuator 400 may be a precision actuator, for example. Ball spline assembly 404, including ball spline carriage 414, shaft 412, and nut (interior to motorized actuator 402), may be a preloaded precision-ground ball spline, for example. In example embodiments, a magnetic or magnetizable ball 416 may be positioned at the distal end of spline 412 for engaging a workpiece.

In example embodiments, a ball spline nut may be positioned within the housing of motorized linear actuator 402, with the ball spline nut converting rotary motion of the included motor into the linear motion just described. In this manner, rotary motion of the motor in one direction may be translated into linear direction in one direction along the motor axis and rotary direction in the opposite direction translated into linear motion in the opposite direction along the motor axis.

In some embodiments, the actuator assembly can include a dampening assembly that reduces a deviation, or wobble, of the ball spline relative to the motor and/or a workpiece engaged by the ball spline. As described in greater detail in the discussion related to FIG. 6, the dampening assembly may include, for example, a spring configured to reduce or eliminate the backlash that may otherwise be generated when the motor switches from one direction of rotation to another, and the motor's shaft switches linear motion correspondingly. The dampening assembly reduces wobble associated with the motor's motion. In various embodiments, a length of the ball spline nut may be chosen according to design requirements as another mechanism to reduce wobble as much as needed for the application, with a longer nut and raceway reducing wobble more than a shorter nut and raceway.

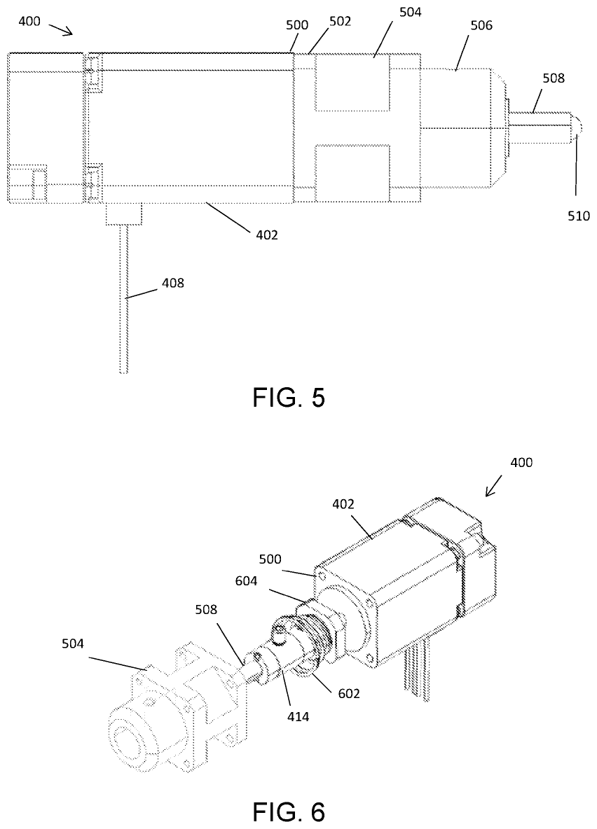

FIG. 5 is a side view of a ball spline assembly of FIG. 4 in assembled form. FIG. 6 is the assembly of FIGS. 4 and 5 in a partially exploded, perspective view. In various embodiments, a spring may be added to the ball spline, as previously described, to reduce or substantially eliminate backlash that may otherwise be generated as the motor changes direction.

The assembly of FIGS. 4, 5, and 6 may include a housing 504 that is attachable, e.g., via screws, a high strength epoxy or weld, or some other form of coupling, to a face 500 of a motor 402, which is shown in part in FIGS. 4, 5, and 6. The motor shaft passes through an opening formed in a base 502 of the housing, where it is attached to the ball-spline shaft via threaded end engaged with the ball spline shaft base encased by the housing. The motor shaft and the ball-spline shaft are coaxial. A ball spline nut may be disposed within the motor housing to dampen vibration and wobble of the ball-spline shaft. Housing 504 may enclose a ball spline shaft base and a spring engaged between the ball spline shaft base and the ball spline carriage 506 configured to reduce or substantially eliminate backlash in the motor 402. The ball spline shaft 508 extends beyond the carriage and, under control of motor 402, extends or retracts along a direction coaxial with the shaft 508 and motor shaft 406 (see FIG. 4).

In various embodiments, the anti-backlash mechanism (for example, a spring configured as just described) is disposed within the housing 504 and arranged to eliminate of substantially reduce unwanted movement, or deviation, of the shaft 412 and, therefore, of the shaft ball end relative to a workpiece it engages.

In the embodiment of FIGS. 4, 5, and 6, the anti-backlash mechanism takes the form of at least one spring or helical spring. In various embodiments, the at least one spring can be a conical helical spring. The ball-spline shaft can include the ball at a distal end and a base at a proximal end, closer to the motor. The motor shaft, ball-spline shaft, and ball-spline nut can form an elongate shaft, or complete actuator shaft, that passes internally through a central spring axis. The central spring axis can be the same as the axis of the coaxial motor and ball-spline shafts.

In the embodiment of FIGS. 5 and 6, the wobble-free motorized actuator 400 comprising an optional spring assembly, as described above. In this example a home flag assembly, which indicates to an electronic controller, such as processor 410 when the motor shaft is in its most-retracted position (that is, “home”) is attached to the motorized actuator 402. This information may be used as a positional reference for all subsequent moves. In this example embodiment a ball-spline spring assembly is attached to the motorized actuator 402 through housing base 502 to motorized actuator face 500.

In FIG. 6, as an example, the spring 602 is disposed between the shaft base 604 and the ball spline carriage 414. In various embodiments, there are various approaches to disposing the spring, or other anti-backlash mechanisms, within the housing.

In various embodiments, the ball end can be used to form up to a five degree of freedom (5DOF) interface with the workpiece. In such embodiments, the ball could comprise, be made of, or include a magnetic material, e.g., a ferrous material. While spring embodiments are shown in the examples provided herein, in other embodiments a different dampening, or anti-backlash, mechanism could be used, such as deformable or compressible element, e.g., a deformable or compressible material or gas. In various embodiments, a plurality of dampening mechanisms could be used, e.g., a plurality of the same type of dampening mechanisms or a plurality of different types of dampening mechanisms. As an example, in various embodiments, a plurality of springs could be disposed in the housing. In various embodiments, a plurality of springs could be disposed in the housing and be coaxial with the motor and ball-spline shafts.

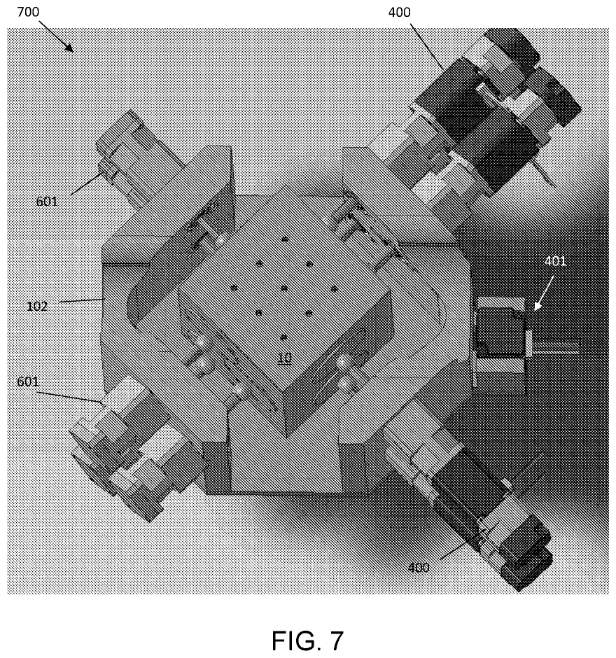

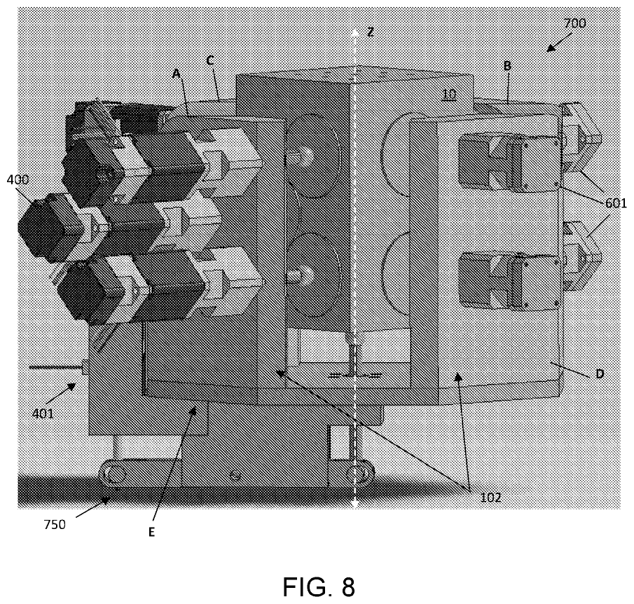

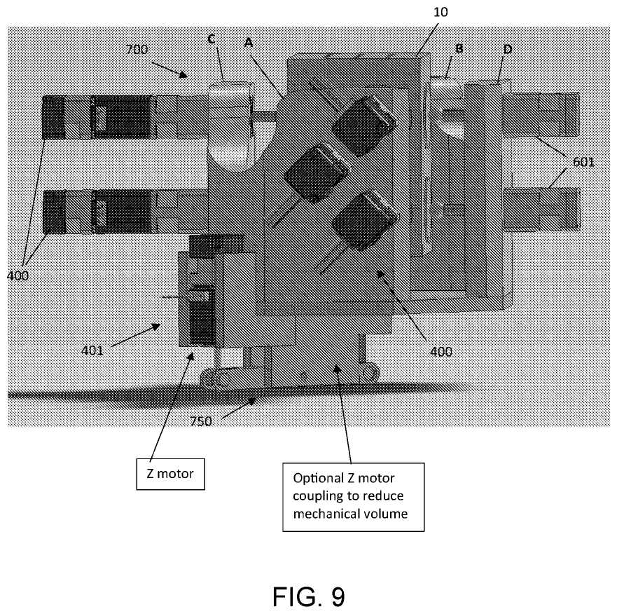

FIG. 7 is a top view of an example embodiment of a micro-positioner 700, in accordance with aspects of the inventive concepts. Micro-positioner 700 may employ a plurality of actuators, including one or more ball spline actuators 400, such as described above. FIG. 7 shows the micro-positioner with the workpiece 10 at a center position, from a top view. FIG. 8 is an angled side view of the micro-positioner 700 of FIG. 7, in accordance with aspects of the inventive concepts. FIG. 8 shows the micro-positioner with the workpiece at a center position, from the side view. FIG. 9 is a side view of the micro-positioner 700 of FIG. 7, in accordance with aspects of the inventive concepts. FIG. 9 shows the micro-positioner with the workpiece at a center position, from another side view.

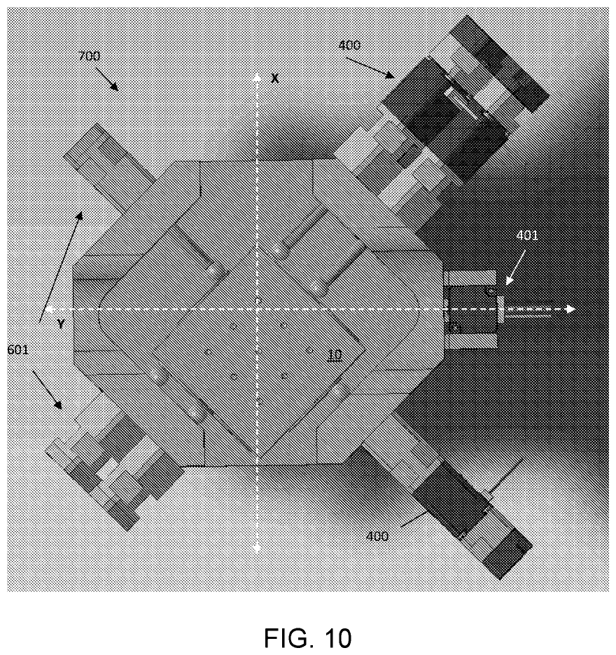

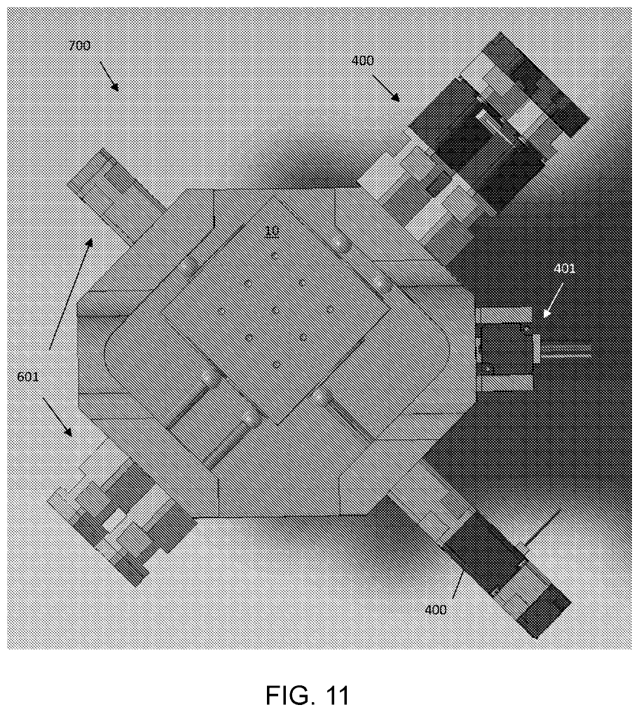

FIG. 10 is another top view of the micro-positioner 700 of FIG. 7, with the workpiece in a maximum x-position, in accordance with aspects of the inventive concepts. FIG. 11 is another top view of the micro-positioner 700 of FIG. 7, with the workpiece in a minimum x-position, in accordance with aspects of the inventive concepts.

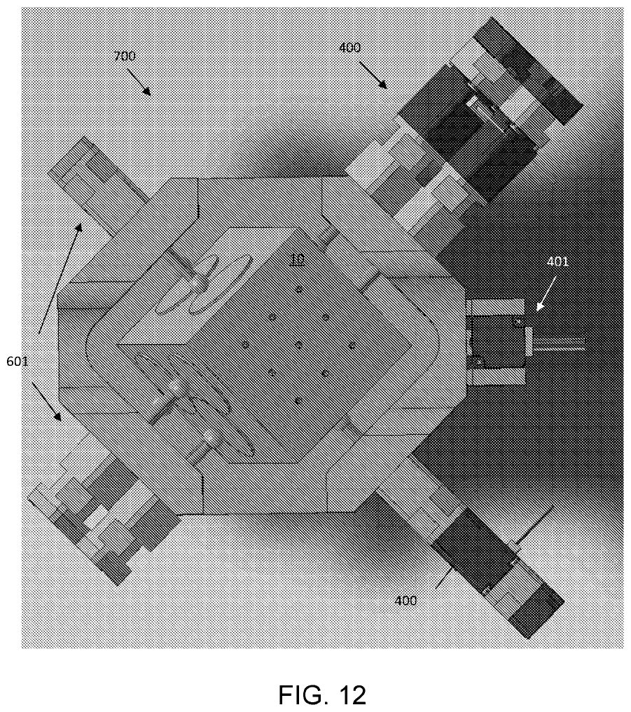

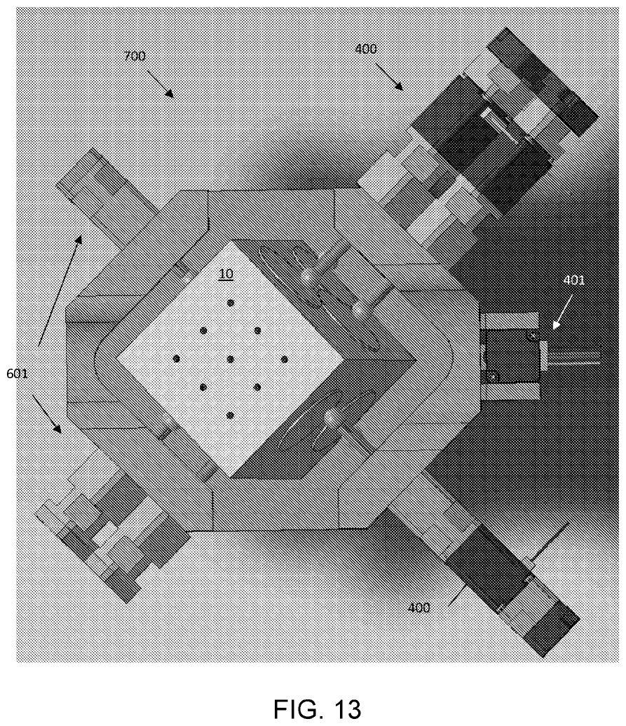

FIG. 12 is another top view of the micro-positioner 700 of FIG. 7, with the workpiece in a maximum yaw position, in accordance with aspects of the inventive concepts. FIG. 13 is another top view of the micro-positioner 700 of FIG. 7, with the workpiece in a minimum yaw position in accordance with aspects of the inventive concepts.

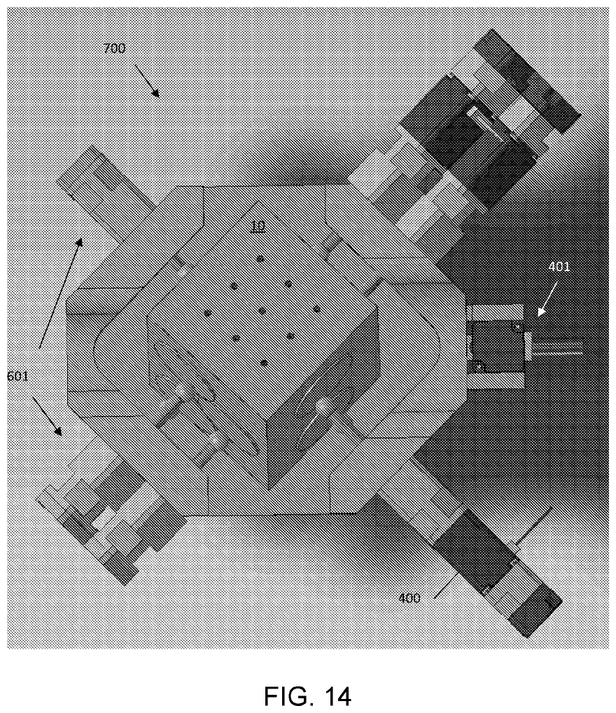

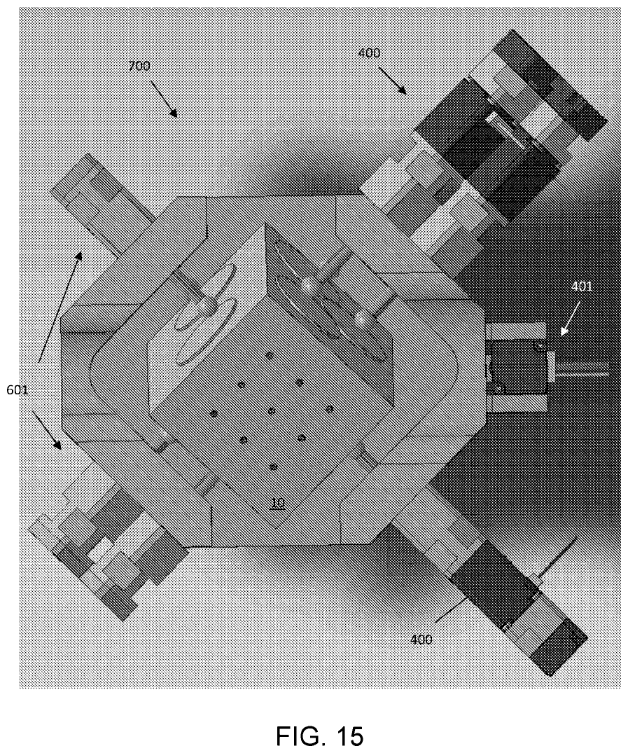

FIG. 14 is another top view of the micro-positioner 700 of FIG. 7, with the workpiece in a maximum pitch position, in accordance with aspects of the inventive concepts. FIG. 15 is another top view of the micro-positioner 700 of FIG. 7, with the workpiece in a minimum pitch position, in accordance with aspects of the inventive concepts.

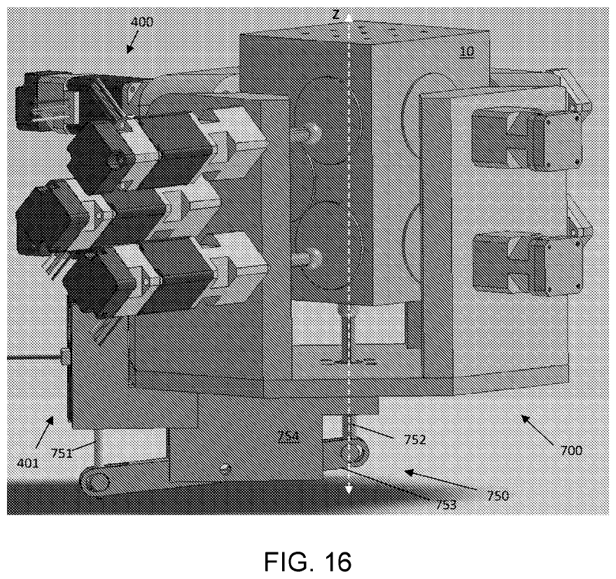

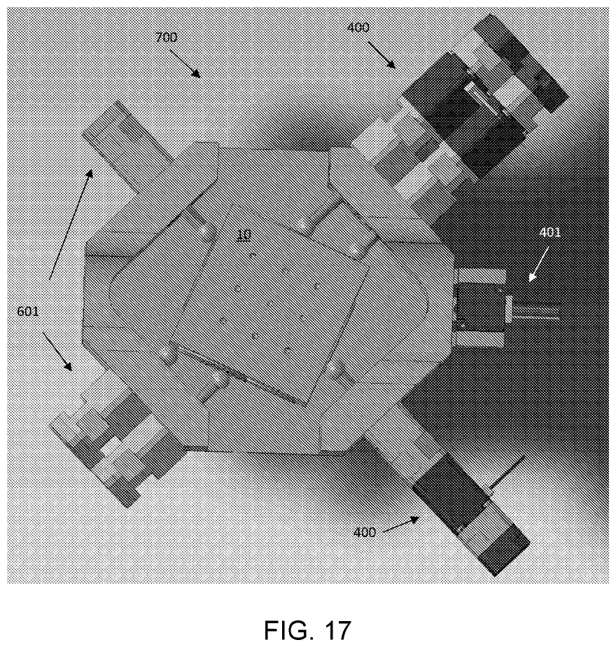

FIG. 16 is another angled side view of the micro-positioner 700 of FIG. 7, with the workpiece in an extended z position, in accordance with aspects of the inventive concepts. FIG. 17 is another top view of the micro-positioner 700 of FIG. 7, with the workpiece rotated in a maximum theta position, in accordance with aspects of the inventive concepts.

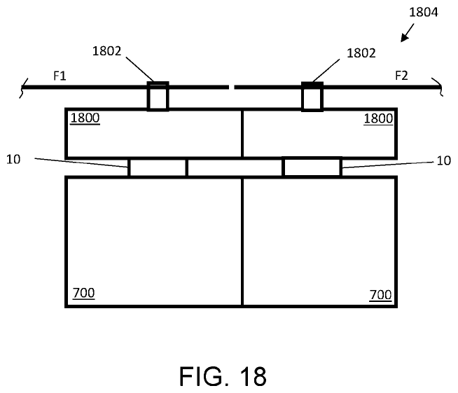

FIG. 18 is a diagram of a fiber splicer 1804 comprising at least one micro-positioner 700, in accordance with the inventive concepts.

Referring to FIGS. 7-17 and 18, a micro-positioner 700 is shown supporting a workpiece 10, such as a block, plate, or an electrical, mechanical, or optical component. In some embodiments, the workpiece may be configured as an element of an optical fiber positioner, which can be useful for positioning at least one optical fiber and/or fiber end. For example, the workpiece may include elements to hold one or more fibers in an orientation determined by a user to facilitate fiber splicing or other optical fiber operations, as depicted in optical fiber splicer 1804 of FIG. 18. The micro-positioner 700 can be used to align one end of a fiber F1 to an end of another fiber F2 for splicing, for example.

FIGS. 7 and 8 show the micro-positioner 700 supporting a workpiece 10. Workpiece 10 may also be referred to herein as a workpiece support 10, as in example embodiments it may support elements, such as elements of an optical system, which may include an optical fiber alignment and/or splicing system. In this embodiment, the micro-positioner 700 includes a carriage 102 having a plurality of side walls A, B, C, D and a bottom wall E defining an internal volume. Thes side walls A, B, C, and D extend from the bottom wall E to form the internal volume. The workpiece can be movable within the volume defined by carriage 102 and its walls A, B, C, D, and E. The micro-positioner 700 also includes a plurality of actuators extending from the plurality of carriage walls A, B, C, D, and E toward the internal volume of the carriage. The actuators are configured to support the workpiece support 10 and move the workpiece in the x, y, and/or z directions. In this embodiment, the plurality of walls and actuators includes at least one active actuator extending from a first side wall and at least one passive actuator extending from a second side wall, opposite the first side wall. In example embodiments the joints formed by the end of the actuators (for example, ball 413) and the workpiece are 5 degree of freedom joints.

An active actuator can be an electro-mechanical actuator that moves in response to an electrical current and/or voltage, such as actuator 400 of FIG. 6. A passive actuator can be a mechanical actuator that moves in response to the application or change in application of a force. A passive actuator can include a spring, or similar compression element, that causes the actuator to provide a force against the workpiece 10. In example embodiments, the actuators are coupled to and extend from the carriage walls toward the internal volume of the carriage. In example embodiments active or passive actuators may employ ball spline elements to substantially reduce or eliminate shaft wobble. Active actuators may employ anti-backlash elements, such as springs, as previously described to substantially reduce or eliminate backlash.

In the example embodiment shown, carriage side wall A includes 3 active actuators 400 and carriage wall A, which is opposite to and parallel with carriage side wall B, includes 3 passive actuators 601. In this embodiment, each active actuator coupled to side wall A is aligned and coaxial with a corresponding passive actuator 601 on the opposite wall, side wall B. As such, two such opposing actuators can form a pair of actuators comprising an active actuator and a passive actuator. In example embodiments the spring force of the passive actuators 601 may be selected to ensure that the workpiece support 10 is fully supported regardless of the position (that is, fully or partially extended, or fully retracted), of the opposing active actuators 400 yet not so strong that the active actuators cannot overcome their force to effectively position the workpiece 10.

In this embodiment, carriage side wall C includes two active actuators 400 and carriage side wall D, which is opposite and parallel to carriage side wall C, includes two corresponding passive actuators 601. As with the actuators of side walls A and B, the actuators of side walls C and D oppose each other. The passive actuators of side wall D are coaxial with the active actuators of side wall C. The actuators of the carriage side walls A, B, C, D can affect different degrees of yaw, pitch, and roll of the workpiece support 10 with respect to a two-dimensional (2D) coordinate system.

The carriage can also include a bottom wall E. The bottom wall E can define a floor of the carriage and a lower boundary of the internal volume defined by the walls of the carriage 102. The bottom wall can include an opening through which a shaft of a bottom actuator 401 extends to engage the workpiece. In this embodiment, only one bottom actuator is shown, but other bottom actuators could be included in other embodiments. In example embodiments the bottom actuator 401 is an active actuator, such as actuator 400, although in some figures motor (Z axis motor) and ball spline shaft are shown offset from one another.

In the example, as shown in FIGS. 8, 9, and 16, an actuator shaft 751 of the bottom actuator 401 can be coupled to a ball spline shaft 752 via a lever or linkage 750. In this embodiment, linkage 750 includes a rocker arm 753 pivotably maintained by a carriage extender 754 at the bottom or carriage 102. Linear movement of the actuator shaft is transferred to the ball spline shaft 752 via rocker arm 753, such that when the actuator shaft 751 extends, the ball spline shaft extends in the positive z direction exerting upward force on workpiece 10. Conversely, when the actuator shaft retracts, the ball spline shaft is pulled down, enabling workpiece 10 to lower in the z direction.

In the example embodiment of FIG. 18 two micro-positioners 700 are positioned proximate one another and are supported on a low-vibration support, such as an optical table. Each micro-positioner 700 supports optical components 1800, for example, on their respective workpiece supports 10. The optical components may be fiber optic splicing components, for example, and the micro-positioners 700 may be employed to precisely align ends of optical fibers F1 and F2 for splicing or for other operations. Clamping mechanisms 1802 may be employed to temporarily fix the optical fibers F1, F2 to the optical fiber system 1804, which may be an optical fiber splicing system.

In example embodiments an active, motorized actuator, such as actuator 400, includes a motor coupled to a ball-spline assembly. A motor shaft is coupled to a ball-spline shaft via a ball-spline coupling or nut. Once coupled, the motor shaft and ball-spline shaft form a single elongate shaft. In example embodiments, the shaft has a ball at its distal end that may be magnetized or magnetizable. Optionally, a home flag assembly can be coupled to the motor to indicate to a electronic controller when the motor shaft is at its most retracted position (home). This is then used as a positional reference for all subsequent moves.

In the figures, all micro-positioner views include the wobble-free actuator design. In various embodiments, a wobble-free actuator may include an electro-mechanical actuator, a ball spline and anti-backlash element such as a spring assembly as previously described. In example embodiments, a wobble-free motor may combine a motor and a ball spline, wherein the spring is omitted. That is, the spring is optional in various embodiments.

In various embodiments, the interfaces between the ball of an actuator, whether passive or active, and workpiece 10 do not need to be magnetic, but one or more could be. In an example embodiment, the bottom (Z axis) ball may be magnetic or magnetizable. In various embodiments, discs in the sides of the workpiece support 10 that contact distal ball-ends of actuators could be any low-friction hard material, such as sapphire, for example.

In various embodiments, the inventive concepts include a combination of passive (e.g., spring) actuators and electro-mechanical actuators on the same side.

While the foregoing has described what are considered to be the best mode and/or other preferred embodiments, it is understood that various modifications can be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

It is appreciated that certain features of the invention, which are, for clarity, described in the context of separate embodiments, may also be provide in combination in a single embodiment. Conversely, various features of the invention which are, for brevity, described in the context of a single embodiment may also be provided separately or in any suitable sub-combination.

For example, it will be appreciated that all of the features set out in any of the claims (whether independent or dependent) can be combined in any given way.
1. An actuator, comprising:
   a motor comprising a motor shaft;
   a ball spline coupled to the motor shaft and driven by the motor; and
   a dampening assembly configured to reduce a deviation in wobble of the ball spline when driven by the motor.
2. The assembly of statement 1, or any other statement of combination of statements, wherein the motor is configured to linearly drive the ball spline.
3. The assembly of statement 1, or any other statement of combination of statements, wherein the ball spline comprises a ball spline shaft and the assembly further comprises a ball-spline nut configured to couple the ball spline shaft to the motor shaft.
4. The assembly of statement 1, 2, or 3, or any other statement of combination of statements, wherein the dampening assembly comprises a backlash reduction assembly configured to reduce motion of the ball spline relative to a workpiece and/or the motor.
5. The assembly of statement 4, or any other statement of combination of statements, wherein the backlash reduction assembly comprises:
   a housing through which passes the motor shaft and/or the ball spline shaft; and
   at least one backlash reduction element disposed within the housing and configured to reduce vibration and/or motion of the motor shaft and/or the ball spline shaft.
6. The assembly of statement 5, or any other statement of combination of statements, wherein the housing encases a portion of the motor shaft and/or the ball spline shaft and the at least one backlash reduction assembly.
7. The assembly statement 4, or any other statement of combination of statements, wherein at least one backlash reduction assembly is coaxial with the motor shaft and/or the ball spline shaft.
8 The assembly of statement 1, or any other statement of combination of statements, wherein the at least one backlash reduction assembly comprises at least one spring.
9. The assembly of statement 1, or any other statement of combination of statements, further comprising a ball or sphere on a distal end of the motor shaft and/or a ball spline shaft coupled to the motor shaft.
10. The assembly of statement 9, or any other statement of combination of statements, wherein the ball or sphere comprises and/or includes a magnetic material.
11. The assembly of statement 1, or any other statement of combination of statements, wherein the wobble-free actuator has a deviation in wobble in a range of between 3 microns to 6 microns.
12. The assembly of statement 1, or any other statement of combination of statements, wherein the wobble-free actuator has a deviation of about 1 micron.
13. The assembly of statement 1, or any other statement of combination of statements, wherein the wobble-free actuator has a deviation of 1 micron, ±50%.
14. A wobble-free actuator assembly, comprising:
a dampening assembly configured to reduce a deviation in wobble of a ball spline when driven by a motor shaft driven by a motor, the dampening assembly comprising:
   a backlash reduction assembly configured to reduce motion of the ball spline relative to a workpiece and/or the motor.
15. The assembly of statement 14, or any other statement of combination of statements, wherein the backlash reduction assembly comprises:
   a housing through which passes the motor shaft and/or a ball spline shaft coupled to the motor shaft; and
   at least one backlash reduction element disposed within the housing and configured to reduce vibration and/or motion of the motor shaft and/or the ball spline shaft.
16. The assembly of statement 15, or any other statement of combination of statements, wherein the housing encases a portion of the motor shaft and/or the ball spline shaft and the at least one backlash reduction assembly.
17. The assembly of statement 14, or any other statement of combination of statements, wherein at least one backlash reduction assembly is coaxial with the motor shaft and/or the ball spline shaft coupled to the motor shaft.
18. The assembly of statement 14, or any other statement of combination of statements, wherein the at least one backlash reduction assembly comprises at least one spring.
19. The assembly of statement 14, or any other statement of combination of statements, further comprising a ball or sphere on a distal end of the motor shaft or a ball spline shaft coupled to the motor shaft.
20. The assembly of statement 19, or any other statement of combination of statements, wherein the ball or sphere comprises and/or includes a magnetic material.
21. The assembly of statement 14, or any other statement of combination of statements, wherein the wobble-free actuator assembly is configured to limit a deviation in wobble of the motor shaft and/or a ball spline shaft coupled to the motor shaft in a range of between 3 microns to 6 microns.
22. The assembly of statement 14, or any other statement of combination of statements, wherein the wobble-free actuator assembly is configured to limit a deviation in wobble of the motor shaft and/or a ball spline shaft coupled to the motor shaft to a deviation of about 1 micron.
23. The assembly of statement 14, or any other statement of combination of statements, wherein the wobble-free actuator assembly is configured to limit a deviation in wobble of the motor shaft and/or a ball spline shaft coupled to the motor shaft to a deviation of 1 micron, ±50%.
24. A wobble-free actuator kit, comprising:
   a motor having a motor shaft;
   a ball spline configured to couple to the motor shaft; and
   a dampening assembly configured to coupled to the motor and to reduce a deviation in wobble of the ball spline when driven by the motor.
25. The kit of statement 24, or any other statement of combination of statements, wherein the motor is configured to linearly drive the ball spline.
26. The kit of statement 24, or any other statement of combination of statements, wherein the ball spline comprises a ball spline shaft and the kit further comprises a ball-spline nut configured to couple the ball spline shaft to the motor shaft.
27. The kit of statement 24, 25, 26, or any other statement of combination of statements, wherein the dampening assembly comprises a backlash reduction assembly configured to reduce motion of the ball spline relative to a workpiece and/or the motor.
28. The kit of statement 27, or any other statement of combination of statements, wherein the backlash reduction assembly comprises:
   a housing through which passes the motor shaft and/or the ball spline shaft; and
   at least one backlash reduction element disposed within the housing and configured to reduce vibration and/or motion of the motor shaft and/or the ball spline shaft.
29. The kit of statement 28, or any other statement of combination of statements, wherein the housing encases a portion of the motor shaft and/or the ball spline shaft and the at least one backlash reduction assembly.
30. The kit of statement 27, or any other statement of combination of statements, wherein at least one backlash reduction assembly is coaxial with the motor shaft and/or the ball spline shaft.
31. The kit of statement 27, or any other statement of combination of statements, wherein the at least one backlash reduction assembly comprises at least one spring.
32. The kit of statement 24, or any other statement of combination of statements, further comprising a ball or sphere on a distal end of the motor shaft and/or a ball spline shaft coupled to the motor shaft.
33. The kit of statement 32, or any other statement of combination of statements, wherein the ball or sphere comprises and/or includes a magnetic material.
34. The kit of statement 24, or any other statement of combination of statements, wherein the wobble-free actuator has a deviation in wobble in a range of between 3 microns to 6 microns.
35. The kit of statement 24, or any other statement of combination of statements, wherein the wobble-free actuator has a deviation of about 1 micron.
36. The kit of statement 24, or any other statement of combination of statements, wherein the wobble-free actuator has a deviation of 1 micron, ±50%.
37. A micro-positioner, comprising:
   a carriage comprising a plurality of walls defining an internal volume; and
   a plurality of actuators extending from the plurality of walls toward the internal volume and configured to support and move a workpiece,
   the plurality of actuators comprising at least one wobble-free actuator, including:
   a motor comprising a motor shaft;
   a ball spline coupled to the motor shaft and driven by the motor; and
   a dampening assembly configured to reduce a deviation in wobble of the ball spline when driven by the motor.
38. The micro-positioner of statement 37, or any other statement of combination of statements, wherein the plurality of actuators includes:
   at least one active actuator extending from a first side wall of the carriage; and
   at least one passive actuator extending from a second side wall of the carriage, opposite the first side wall, wherein the joints formed by the end of the actuators and the workpiece are five degree of freedom joints.
39. The micro-positioner of statement 37 or 38, or any other statement of combination of statements, wherein the first side wall further includes at least one passive actuator and the second side wall further includes at least one active actuator.
40. The micro-positioner of statement 37 or 38, or any other statement of combination of statements, wherein the plurality of actuators is configured to positionally manipulate the workpiece within at least a two-dimensional (2D) coordinate system.
41. The micro-positioner of statement 37 or 38, or any other statement of combination of statements, wherein the plurality of actuators is configured to positionally manipulate the workpiece within a three-dimensional (3D) coordinate system.
42. The micro-positioner of statement 37 or 38, or any other statement of combination of statements, wherein the first side wall and the second side wall are parallel side walls and at least one of the active actuators is a wobble-free actuator.
43. The micro-positioner of statement 37 or 38, or any other statement of combination of statements, wherein the carriage further comprises a third side wall and a fourth side wall opposite the third side wall.
44. The micro-positioner of statement 43, or any other statement of combination of statements, wherein each of the plurality of walls includes one or more actuators from the plurality of actuators extending toward the internal volume.
45. The micro-positioner of statement 44, or any other statement of combination of statements, wherein actuators extending from the first and second side walls extend and retract in an x-axis and actuators extending from the third and fourth side walls extend and retract in an y-axis.
46. The micro-positioner of statement 43, or any other statement of combination of statements, wherein the carriage further comprises a bottom wall, from which the first, second, third, and fourth walls extend.
47. The micro-positioner of statement 46, or any other statement of combination of statements, wherein the plurality of actuators includes at least one bottom actuator arranged to engage a bottom surface of the workpiece.
48. The micro-positioner of statement 47, or any other statement of combination of statements, wherein the at least one bottom actuator is coupled to a bottom ball spline shaft through a lever and/or linkage and the bottom ball spline shaft extends through the bottom wall and engages the bottom surface of the workpiece.
49. The micro-positioner of statement 48, or any other statement of combination of statements, wherein the bottom ball spline shaft is configured to extend and retract along a z-axis.
50. The micro-positioner of statement 37, or any other statement of combination of statements, wherein the dampening comprises:
   a backlash reduction assembly configured to reduce motion of the ball spline relative to a workpiece and/or the motor.
51. The micro-positioner of statement 50, or any other statement of combination of statements, wherein the backlash reduction assembly comprises:
   a housing through which passes the motor shaft and/or a ball spline shaft coupled to the motor shaft; and
   at least one backlash reduction element disposed within the housing and configured to reduce vibration and/or motion of the motor shaft and/or the ball spline shaft.
52. The micro-positioner of statement 50, or any other statement of combination of statements, wherein the housing encases a portion of the motor shaft and/or the ball spline shaft and the at least one backlash reduction assembly.
53. The micro-positioner of statement 50, or any other statement of combination of statements, wherein at least one backlash reduction assembly is coaxial with the motor shaft and/or the ball spline shaft coupled to the motor shaft.
54. The micro-positioner of statement 50, or any other statement of combination of statements, wherein the at least one backlash reduction assembly comprises at least one spring.
55. The micro-positioner of statement 50, or any other statement of combination of statements, further comprising a ball or sphere on a distal end of the motor shaft or a ball spline shaft coupled to the motor shaft.
56. The micro-positioner of statement 55, or any other statement of combination of statements, wherein the ball or sphere comprises and/or includes a magnetic material.
57. The micro-positioner of statement 37 or 50, or any other statement of combination of statements, wherein the wobble-free actuator assembly is configured to limit a deviation in wobble of the motor shaft and/or a ball spline shaft coupled to the motor shaft in a range of between 3 microns to 6 microns.
58. The micro-positioner of statement 37 or 50, or any other statement of combination of statements, wherein the wobble-free actuator assembly is configured to limit a deviation in wobble of the motor shaft and/or a ball spline shaft coupled to the motor shaft to a deviation of about 1 micron.
59. The micro-positioner of statement 37 or 50, or any other statement of combination of statements, wherein the wobble-free actuator assembly is configured to limit a deviation in wobble of the motor shaft and/or a ball spline shaft coupled to the motor shaft to a deviation of 1 micron, ±50%.

1. An actuator, comprising:
a motor comprising a motor shaft;
a ball spline coupled to the motor shaft and driven by the motor; and
a dampening assembly configured to reduce a deviation in wobble of the ball spline when driven by the motor.

2.-59. (canceled).
